(19) United States
(12) Patent Application Publication
(10) Pub. No.: US 2025/0290518 A1
(43) Pub. Date: Sep. 18, 2025

(54) VARIABLE ORIFICE FLOW DEVICES FOR CONSTANT FLOW FLOWLINES

(71) Applicant: EXXONMOBIL TECHNOLOGY AND ENGINEERING COMPANY, Spring, TX (US)

(72) Inventors: Terry P. MAYEUX, Orange, TX (US); Waylon L. PRINE, Kountze, TX (US); Mark P. DIB, Houston, TX (US); Brandon P. JOHNSON, Nederland, TX (US)

(73) Assignee: EXXONMOBIL TECHNOLOGY AND ENGINEERING COMPANY, Spring, TX (US)

(21) Appl. No.: 19/075,480

(22) Filed: Mar. 10, 2025

Related U.S. Application Data
(60) Provisional application No. 63/564,816, filed on Mar. 13, 2024.

(51) Int. Cl. F04D 15/00; B08B 9/032

(52) U.S. Cl. CPC F04D 15/0022; B08B 9/0321

(57) ABSTRACT

A mechanical system includes a flowline through which a fluid is circulated, and a variable orifice flow device arranged in the flowline and providing a valve body that includes an inlet port, an outlet port, and a flow path extending between the inlet and outlet ports. The variable orifice flow device is actuatable between a fully closed position, where an open orifice is defined in the variable orifice flow device to allow the fluid to circulate through the flow path at a first flow rate, and an open position, where the fluid circulates through the flow path at a second flow rate greater than the first flow rate.

### FIELD

This application relates to fluid flow control and, more particularly, to variable orifice flow devices that allow constant flow through flowlines and are actuatable for self-cleaning.

### BACKGROUND

Some mechanical systems include a flowline through which a constant flow of a fluid is maintained during operation for a variety of purposes. Such systems often include a fixed orifice arranged in the flowline to regulate the flow of the fluid therethrough. Over time, however, the fixed orifice can become plugged with debris or residue may increasingly build at the orifice location. In such events, the mechanical system is typically shut down and the fixed orifice is removed and manually cleaned before restarting the mechanical system.

Examples of such mechanical systems are industrial pumps and compressors (collectively referred to herein as “pumps” or “the pump”), which oftentimes include a seal support system operable to maintain proper lubrication, pressure, temperature, and solids management at a mechanical seal. Such seal support systems typically include a recirculation flowline to circulate a fluid to or from a seal chamber adjacent the mechanical seal. The seal support system not only operates to seal between moving mechanical parts, but also creates an ideal work environment for the mechanical seal in order to avoid wear and failures, thus prolonging its useful life.

The fluid required for the seal support system can either originate from the process itself (e.g., process fluid) or from an external source, depending upon what is required for the process. In applications that use the process fluid, the fluid can be extracted from either the suction (inlet) or discharge (outlet) ends of the pump. The seal support system redirects the process fluid to or from the seal chamber using a flowline with a fixed orifice arranged therein to help regulate the flow of the process fluid therethrough. Connecting to the discharge end allows a portion of the high-pressure process fluid to travel to the seal chamber, support the mechanical seal, and subsequently re-enter the process stream. Connecting to the suction end draws a portion of the process fluid within the pump to migrate past (through) the mechanical seal into the seal chamber, and subsequently be circulated to the suction end to re-enter the process stream. In either scenario, the process fluid provides lubrication and cooling for the mechanical seal, while flushing solids away so that it can maintain appropriate contact and keep the process fluid inside the pump.

Debris and other impurities are often entrained in the process fluid and, as a result, debris can gradually lodge at the fixed orifice and deposits (residue) can progressively build at the restriction in the fixed orifice. Over time, the fixed orifice becomes plugged, which can make the mechanical seal run hot and dry, and potentially fail prematurely. To remedy this, the pump must be stopped, isolated, deinventoried, cleared for maintenance, and the fixed orifice cleaned before restarting pump operation.

What is needed is a device and system that helps remove the debris and residue accumulation at fixed orifice flowline locations while allowing the pump to remain in service, i.e., without the need to shut down the pump, isolate, deinventory, clearing for maintenance, and cleaning the fixed orifice.

### SUMMARY OF DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

In one or more embodiments, a pump is disclosed and includes a casing, a mechanical seal arranged within the casing, a flowline in fluid communication with the mechanical seal to circulate a flush and cooling fluid to or from the mechanical seal, and a variable orifice flow device arranged in the flowline and actuatable between a fully closed position, where an open orifice is defined in the variable orifice flow device and allows the flush and cooling fluid to circulate through the variable orifice flow device at a first flow rate, and an open position, where the flush and cooling fluid circulates through the variable orifice flow device at a second flow rate greater than the first flow rate.

In one or more additional embodiments, a method is disclosed and includes the steps of circulating a flush and cooling fluid through a flowline in fluid communication with a mechanical seal arranged within a casing of a pump, conveying the flush and cooling fluid to a variable orifice flow device arranged in the flowline, circulating the flush and cooling fluid through the variable orifice flow device in a fully closed position, where an open orifice is defined in the variable orifice flow device to allow the flush and cooling fluid to circulate through the variable orifice flow device at a first flow rate, transitioning the variable orifice flow device away from the fully closed position, and circulating the flush and cooling fluid through the variable orifice flow device at a second flow rate greater than the first flow rate with the variable orifice flow device transitioned away from the fully closed position.

In one or more additional embodiments, a mechanical system is disclosed and includes a flowline through which a fluid is circulated, and a variable orifice flow device arranged in the flowline and providing a valve body that includes an inlet port, an outlet port, and a flow path extending between the inlet and outlet ports, wherein the variable orifice flow device is actuatable between a fully closed position, where an open orifice is defined in the variable orifice flow device to allow the fluid to circulate through the flow path at a first flow rate, and an open position, where the fluid circulates through the flow path at a second flow rate greater than the first flow rate.

### BRIEF DESCRIPTION OF THE DRAWINGS

The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIGS. 1A and 1B are schematic diagrams of example mechanical systems that may incorporate the principles of the present disclosure.

FIGS. 2A and 2B are partial, cross-sectional side views of an example variable orifice flow device, according to one or more embodiments.

FIG. 3 is a schematic flow chart of an example method that may incorporate the principles of the present disclosure.

### DETAILED DESCRIPTION

This application relates to fluid flow control and, more particularly, to variable orifice flow devices that allow constant flow through flowlines and are actuatable for self-cleaning.

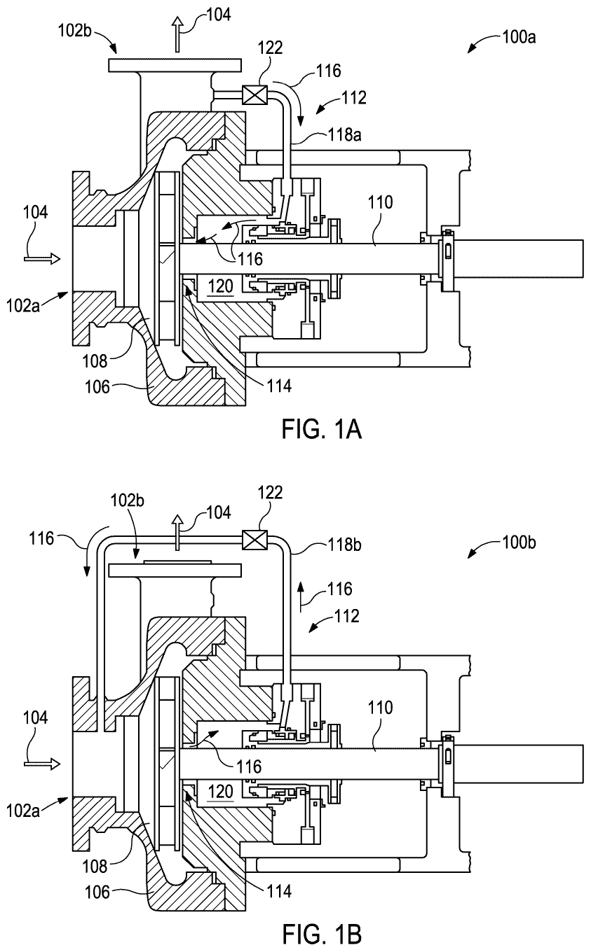

FIGS. 1A and 1B are schematic diagrams of example mechanical systems 100a and 100b, respectively, which may incorporate the principles of the present disclosure. In some embodiments, each mechanical system 100a,b may comprise a pump or a compressor operable to pump or compress a fluid (e.g., a gas, a liquid, or a combination of both). The principles of the present disclosure, however, are not limited to pumps and compressors. Rather, other examples of the mechanical systems 100a,b include, but are not limited to, a turbine, a mixer, a process sample system, a process analyzer, or any combination thereof. For purposes of discussion, however, the mechanical systems 100a,b will be described with reference to a pump or compressor, collectively referred to herein as “pump”.

As illustrated, each mechanical system 100a,b includes an inlet 102a and an outlet 102b. In some applications, the mechanical systems 100a,b receive a low-pressure process fluid 104 at the inlet 102a (i.e., a “suction” inlet), pump the process fluid 104, and discharge a high-pressure process fluid 104 at the outlet 102b (e.g., a “discharge” outlet). In embodiments where one or both of the mechanical systems 100a,b comprise a turbine, however, the inlet 102a would receive a high-pressure process fluid, and the outlet 102b would discharge a low-pressure process fluid 104.

Examples of the process fluid 104 include, but are not limited to, a gas and a liquid. Example liquid include, but are not limited to, water, a hydrocarbon, a lubricating fluid, a cooling fluid, a caustic, an acid, or any combination thereof.

Some mechanical systems, such as the mechanical systems 100a,b, include a casing 106 that houses an impeller 108 operatively coupled to a drive shaft 110. In some applications, the inlet 102a and the outlet 102b may form part of the casing 106, but could alternatively comprise separate component parts that are coupled (attached) thereto. The impeller 108 is rotatably mounted within the casing 106 and, in some embodiments, is driven (rotated) by rotation of the drive shaft 110. In other embodiments, however, the process fluid 104 causes the impeller 108 to rotate, which causes the drive shaft 110 to rotate.

Some mechanical systems, such as the mechanical systems 100a ,b, further include a seal support system 112 operable to help maintain the process fluid 104 within the casing 106. As illustrated, the seal support system 112 includes a mechanical seal 114 arranged at an aperture defined in the casing 106 and through which the drive shaft 110 extends. The mechanical seal 114 is operable to contain the process fluid 104 within the interior of the casing 106 and withstand friction caused by rotation of the drive shaft 110, which supports the turbine 108 as it rotates. The seal support system 112 further includes a flowline 118a (FIG. 1A) and 118b (FIG. 1B) configured to circulate a flush and cooling fluid 116 to or from the mechanical seal 114, and thereby maintain a thin film of fluid at the interface between the drive shaft 110 and the mechanical seal 114, which helps lubricate the mechanical seal 114.

In the illustrated embodiments, the flush and cooling fluid 116 can either come from the process fluid 104 being pumped or from an external source. In FIG. 1A, for example, the flush and cooling fluid 116 comprises a portion of the high-pressure process fluid 104 extracted from the outlet 102b and received within a flowline 118a extending between the outlet 102b and a seal chamber 120 in fluid communication with the mechanical seal 114. Once in the seal chamber 120, a thin film of the flush and cooling fluid 116 migrates through the interface between the drive shaft 110 and the mechanical seal 114 to perform a sealing and cleaning function. Because the flowline 118a is fluidly coupled to the outlet 102b, which exhibits high pressure, the flush and cooling fluid 116 is forced through the gap at the mechanical seal 114. After passing through the mechanical seal 114, the flush and cooling fluid 116 rejoins the process fluid 104 within the casing 106.

In FIG. 1B, the flush and cooling fluid 116 comprises a portion of the process fluid 104 originating within the casing 106 and migrating through the interface between the drive shaft 110 and the mechanical seal 114 and into the sealing chamber 120. The seal support system 112 of FIG. 1B includes a flowline 118b that extends between the seal chamber 120 and the inlet 102a. Because the flowline 118b is fluidly coupled to the inlet 102a, which exhibits a low pressure, the flush and cooling fluid 116 is drawn (sucked) through the gap at the mechanical seal 114, fed into the seal chamber 120, and subsequently drawn through the flowline 118b to rejoin the low pressure process fluid 104 at the inlet 102a.

As illustrated, the flowline 118a,b in most mechanical systems, such as the mechanical systems 100a,b, include a fixed flow orifice 122 operable to regulate the flow rate and pressure of the flush and cooling fluid 116 circulating therethrough. Debris and other impurities are often entrained in the flush and cooling fluid 116 and, as a result, debris gradually lodges in the fixed flow orifice 122 and deposits and residue progressively build at the restriction in the fixed flow orifice 122. Over time, the fixed flow orifice 122 becomes plugged, which can make the mechanical seal 114 run hot and dry, and potentially fail prematurely. To remedy this, operation of the mechanical system 100a,b must be stopped, isolated from the process, deinventoried, cleared for maintenance, and the fixed flow orifice 122 must be cleaned before restarting operation.

According to embodiments of the present disclosure, the fixed flow orifice 122 may be replaced with a non-fixed or “variable” orifice flow device. As described herein, the variable (non-fixed) orifice flow device provides an open orifice when it is in a fully closed position, thereby allowing the flush and cooling fluid 116 to circulate through the flowline 118a,b during normal operation. If the orifice becomes plugged, the variable (non-fixed) orifice flow device may be actuated (operated) toward an open position where the size (e.g., diameter) of the flow path at the open orifice increases and thereby allows the circulating flush and cooling fluid 116 to flush out (evacuate) any debris or residue that may be present at the open orifice. For mechanical systems that have frequent problems with orifice plugging, the variable orifice flow device may be actuated during each operator inspection round to ensure consistent and reliable operation.

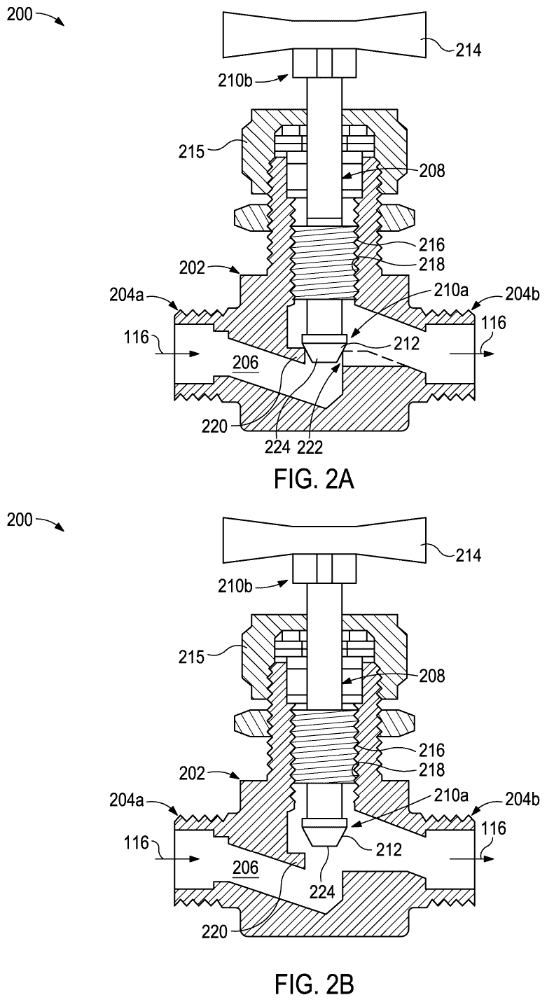

FIGS. 2A and 2B are partial, cross-sectional side views of an example variable orifice flow device 200, according to one or more embodiments. The variable orifice flow device 200 may replace the fixed flow orifice 122 of FIGS. 1A and 1B and, therefore, may be used with the mechanical systems 100a,b (FIGS. 1A and 1B) and arranged in the flowlines 118a,b (FIGS. 1A and 1B). In some embodiments, the variable orifice flow device 200 may comprise an actuatable valve movable between a fully closed position and an open position. FIG. 2A depicts the variable orifice flow device 200 in the fully closed position, and FIG. 2B depicts the variable orifice flow device 200 in the open position and otherwise transitioned away from the fully closed position.

As illustrated, the variable orifice flow device 200 includes a valve body 202 that defines or otherwise provides a first or “inlet” port 204a, a second or “outlet” port 204b, and a flow path 206 extending between the inlet and outlet ports 204a,b. In some embodiments, as illustrated, one or both of the inlet and outlet ports 204a,b may be threaded (e.g., external threading) to enable the variable orifice flow device 200 to be operatively and fluidly coupled to an adjacent structure, such as the flowlines 118a,b (FIGS. 1A-1B). During operation, a fluid (e.g., the flush and cooling fluid 116) may circulate from the flowline 118a,b and through the flow path 206 between the inlet and outlet ports 204a,b.

The variable orifice flow device 200 also includes an adjustable valve member 208 movably positioned within the valve body 202 and having opposing first and second ends 210a and 210b. A head 212 is provided at the first end 210a, and a user interface or “handle” 214 is provided at the second end 210a. The adjustable valve member 208 is secured within the valve body 202 with a valve bonnet 215 operatively coupled to (e.g., threaded) the valve body 202. In some embodiments, as illustrated, external threading 216 may be provided and otherwise defined on the adjustable valve member 208 and may be threadably engageable with internal threading 218 defined on an inner surface of the valve body 202. The variable orifice flow device 200 may be actuated by rotating the adjustable valve member 208, which causes the threading 216, 218 to interact and thereby move (translate) the adjustable valve member 208 further in or out of the valve body 202. In some embodiments, this can be accomplished by manually rotating the adjustable valve member 208 via the handle 214. In other embodiments, however, rotating the adjustable valve member 208 may be done via an automated system, including a motor (or servo) selectively operable to rotate the adjustable valve member 208.

As indicated above, the variable orifice flow device 200 is depicted in FIG. 2A in the fully closed position. More specifically, when the variable orifice flow device 200 is in the fully closed position, the head 212 engages a radial shoulder or “seating surface” 220 defined by the valve body 202 within the flow path 206. The seating surface 220, however, does not engage or surround the entire head 212, but rather engages against only an adjacent portion of the head 212 such that an open orifice 222 is defined in the flow path 206 between the head 212 and the valve body 202 when the adjustable valve member 208 is in the fully closed position. The open orifice 222 will allow a regulated (known) amount of flow (i.e., a first flow rate), based on the orifice size and process conditions of the flush and cooling fluid 116 to circulate therethrough.

Accordingly, the variable orifice flow device 200 is always technically open, and otherwise flow of the flush and cooling fluid 116 always circulates through the flow path 206. More specifically, when the variable orifice flow device 200 is in the fully closed position, a smaller, regulated amount (i.e., the first flow rate) of the flush and cooling fluid 116 circulates through the flow path 206 via the open orifice 222. Consequently, as used herein, the phrase “fully closed position” refers to a position of the adjustable valve member 208 where a small amount (i.e., a first flow rate) of fluid is able to flow, migrate, or otherwise leak past the adjustable valve member 208. Moreover, when the variable orifice flow device 200 is moved away from the fully closed position, as shown in FIG. 2B, the head 212 disengages from the seating surface 220 such that an increased amount (i.e., a second flow rate greater than the first flow rate) of the flush and cooling fluid 116 is able to circulate past the adjustable valve member 208 (e.g., the head 212) and through the flow path 206.

In some embodiments, the variable orifice flow device 200 may comprise a modified needle valve, or the like. In such embodiments, portions of the flow path 206 may be altered to enable formation of the open orifice 222 when the adjustable valve member 208 is in the fully closed position. More specifically, FIG. 2A depicts a portion 224 (shown in dashed lines) that may be removed (e.g., drilled or milled out) from the flow path 206. The portion 224 may be accessed with a drill bit or an end mill via the outlet port 204b, for example. In some embodiments, the portion 224 may be removed from the flow path 206 such that an arcuate gap or channel remains in the portion 224, thereby enabling the open orifice 222 to be defined when the head 212 engages the seating surface 220. In at least one embodiment, the open orifice 222 may exhibits approximately a ⅛ inch equivalent diameter when the adjustable valve member 208 is in the fully closed position. In other embodiments, however, the open orifice 222 may exhibit a diameter greater or less than ⅛ inch, without departing from the scope of the disclosure.

Moreover, in embodiments where the variable orifice flow device 200 comprises a modified needle valve, portions of the adjustable valve member 208 may also be modified. In particular, in some applications, the head 212 may be modified and otherwise milled to exhibit a generally frustoconical shape that defines a flat bottom 224. In other embodiments, the variable orifice flow device 200 may comprise another type of modified valve such as a gate valve.

In example operation of the variable orifice flow device 200, the adjustable valve member 208 may be placed in the fully closed position as shown in FIG. 2A, where the head 212 engages the seating surface 220. In the fully closed position, the open orifice 222 is defined between the head 212 and the valve body 202, thereby allowing a small amount of the flush and cooling fluid 116 to circulate through the flow path 206 during normal operation. Over time, debris and other impurities entrained in the flush and cooling fluid 116 may gradually build at the open orifice 222, thereby progressively reducing the flow rate through the open orifice 222. Debris and residue, for example, may build up on surfaces of the head 212, the seating surface 220, and various inner surfaces of the flow path 206.

The debris, residue, and other impurities built up or lodged at the location of the open orifice 222 may be removed by actuating the variable orifice flow device 200, and otherwise moving the adjustable valve member 208 away from the fully closed position, as shown in FIG. 2B. As indicated above, actuating the variable orifice flow device 200 may be accomplished by rotating the adjustable valve member 208 in a first angular direction (e.g., counter clockwise), which moves the adjustable valve member 208 away from the fully closed position by separating the head 212 from the seating surface 220. As the head 212 moves away from the seating surface 220, the flow rate of the flush and cooling fluid 116 through the flow path 206 and past the adjustable valve member 208 increases from a first flow rate to a second flow rate, where the second flow rate is greater than the first flow rate. The increased flow rate of the flush and cooling fluid 116 may help remove (evacuate) debris and residue that may be built up on portions of flow path 206. In some cases, the increased flow rate of the flush and cooling fluid 116 may also generate turbulent flow conditions capable of agitating built up debris and residue, and thereby flushing the flow path 206 of debris and residue.

Once the debris and residue is sufficiently flushed from the flow path 206, the variable orifice flow device 200 may again be actuated to move the adjustable valve member 208 back to the fully closed position. To accomplish this, the adjustable valve member 208 may be rotated in a second angular direction (e.g., clockwise) until the head 212 engages the seating surface 220 and thereby prevents the adjustable valve member 208 from rotating any further. In embodiments where the head 212 is milled to include the flat bottom 224, the flat bottom 224 may prove advantageous in minimizing restriction to flow of the flush and cooling fluid 116 through the flow path 206 at the open orifice 222. Moreover, it may be more difficult for debris and residue to build up on the flat bottom 224 of the head 212.

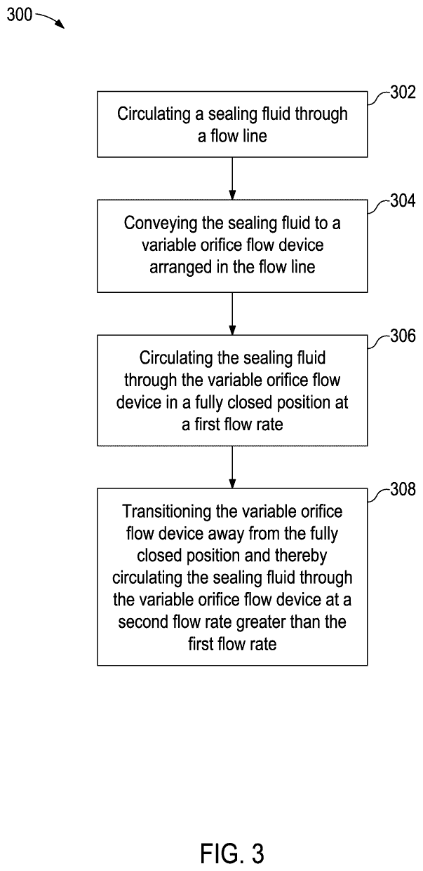

FIG. 3 is a schematic flow chart of an example method 300 that may incorporate the principles of the present disclosure. As illustrated, the method 300 may include circulating a flush and cooling fluid through a flowline, as at 302, where the flowline is in fluid communication with a mechanical seal arranged within a casing of a pump. The method 300 may further include conveying the flush and cooling fluid to a variable orifice flow device arranged in the flowline, as at 304. The flush and cooling fluid may be circulated through the variable orifice flow device with the variable orifice flow device in a fully closed position, as at 306. When the variable orifice flow device is in the fully closed position, an open orifice is defined in the variable orifice flow device and allows the flush and cooling fluid to circulate through the variable orifice flow device at a first flow rate. The method 300 may further include transitioning the variable orifice flow device away from the fully closed position and thereby circulating the flush and cooling fluid through the variable orifice flow device at a second flow rate greater than the first flow rate, as at 308.

### Embodiments Listing

The present disclosure provides, among others, the following examples, each of which may be considered as optionally including any alternate example.

Clause 1: A pump includes a casing, a mechanical seal arranged within the casing, a flowline in fluid communication with the mechanical seal to circulate a flush and cooling fluid to or from the mechanical seal, and a variable orifice flow device arranged in the flowline and actuatable between a fully closed position, where an open orifice is defined in the variable orifice flow device and allows the flush and cooling fluid to circulate through the variable orifice flow device at a first flow rate, and an open position, where the flush and cooling fluid circulates through the variable orifice flow device at a second flow rate greater than the first flow rate.

Clause 2: The pump of Clause 1, further comprising an inlet that receives a process fluid into the casing, an outlet that discharges the process fluid from the casing, an impeller rotatably arranged within the casing, and a drive shaft operatively coupled to the impeller and extending through an aperture defined in the casing, the mechanical seal being arranged at the aperture, wherein the flush and cooling fluid comprises a portion of the process fluid.

Clause 3: The pump of Clause 2, wherein the flowline extends between the outlet and a seal chamber in fluid communication with the mechanical seal, and wherein the flush and cooling fluid comprises a portion of the process fluid extracted from the outlet.

Clause 4: The pump of Clause 2, wherein the flowline extends between the inlet and a seal chamber in fluid communication with the mechanical seal, and wherein the flush and cooling fluid is conveyed from the mechanical seal to the inlet.

Clause 5: The pump of Clause 2, wherein the process fluid comprises a liquid selected from the group consisting of a hydrocarbon, water, a cooling fluid, a caustic, an acid, and any combination thereof.

Clause 6: The pump of Clause 1, wherein the variable orifice flow device includes a valve body that provides an inlet port, an outlet port, and a flow path extending between the inlet and outlet ports, an adjustable valve member movably positioned within the valve body and having opposing first and second ends, and a head provided at the first end and engageable with a seating surface defined by the valve body within the flow path, wherein, when the variable orifice flow device is in the fully closed position, the head engages the seating surface to define the open orifice within the flow path.

Clause 7: The pump of Clause 6, wherein the head exhibits a generally frustoconical shape that defines a flat bottom.

Clause 8: The pump of Clause 6, wherein the variable orifice flow device further includes a handle provided at the second end, and wherein manually rotating the handle causes the adjustable valve member to translate within the valve body and thereby transition the variable orifice flow device between the fully closed and open positions.

Clause 9: The pump of Clause 6, wherein the adjustable valve member is rotated via a motor to transition the variable orifice flow device between the fully closed and open positions.

Clause 10: A method includes circulating a flush and cooling fluid through a flowline in fluid communication with a mechanical seal arranged within a casing of a pump, conveying the flush and cooling fluid to a variable orifice flow device arranged in the flowline, circulating the flush and cooling fluid through the variable orifice flow device in a fully closed position, where an open orifice is defined in the variable orifice flow device to allow the flush and cooling fluid to circulate through the variable orifice flow device at a first flow rate, transitioning the variable orifice flow device away from the fully closed position, and circulating the flush and cooling fluid through the variable orifice flow device at a second flow rate greater than the first flow rate with the variable orifice flow device transitioned away from the fully closed position.

Clause 11: The method of Clause 10, wherein circulating the flush and cooling fluid through the variable orifice flow device at the second flow rate further comprises removing debris and residue from the flow path as the flush and cooling fluid circulates through the variable orifice flow device.

Clause 12: The method of Clause 11, further comprising generating turbulent flow conditions within the flow path as the flush and cooling fluid circulates through the variable orifice flow device at the second flow rate.

Clause 13: The method of Clause 10, wherein an impeller is rotatably arranged within the casing and a drive shaft is operatively coupled to the impeller and extends through an aperture defined in the casing where the mechanical seal is arranged, the method further comprising receiving a process fluid into the casing at an inlet, discharging the process fluid from the casing at an outlet, and using a portion of the process fluid as the flush and cooling fluid.

Clause 14: The method of Clause 13, wherein the flowline extends between the outlet and a seal chamber in fluid communication with the mechanical seal, the method further comprising extracting a portion of the process fluid from the outlet to serve as the flush and cooling fluid.

Clause 15: The method of Clause 13, wherein the flowline extends between the inlet and a seal chamber in fluid communication with the mechanical seal, the method further comprising conveying the flush and cooling fluid from the mechanical seal to the inlet.

Clause 16: The method of Clause 10, wherein the variable orifice flow device includes a valve body that provides an inlet port, an outlet port, and a flow path extending between the inlet and outlet ports, an adjustable valve member movably positioned within the valve body and having opposing first and second ends, and a head provided at the first end and engageable with a seating surface defined by the valve body within the flow path, the method further comprising engaging the head against the seating surface when the variable orifice flow device is in the fully closed position, and thereby defining the open orifice within the flow path.

Clause 17: The method of Clause 16, wherein the variable orifice flow device further includes a handle provided at the second end, and wherein transitioning the variable orifice flow device away from the fully closed position comprises rotating the handle and thereby causing the adjustable valve member to translate within the valve body such that the head disengages with the seating surface.

Clause 18: A mechanical system includes a flowline through which a fluid is circulated, and a variable orifice flow device arranged in the flowline and providing a valve body that includes an inlet port, an outlet port, and a flow path extending between the inlet and outlet ports, wherein the variable orifice flow device is actuatable between a fully closed position, where an open orifice is defined in the variable orifice flow device to allow the fluid to circulate through the flow path at a first flow rate, and an open position, where the fluid circulates through the flow path at a second flow rate greater than the first flow rate.

Clause 19: The mechanical system of Clause 18, wherein the variable orifice flow device further includes an adjustable valve member movably positioned within the valve body and having opposing first and second ends, and a head provided at the first end and engageable with a seating surface defined by the valve body within the flow path, wherein, when the variable orifice flow device is in the fully closed position, the head engages the seating surface to define the open orifice within the flow path.

Clause 20: The mechanical system of Clause 19, wherein the variable orifice flow device further includes a handle provided at the second end, and wherein manually rotating the handle causes the adjustable valve member to translate within the valve body and thereby transition the variable orifice flow device between the fully closed and open positions.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While methods may be described herein in terms of “comprising” various components or steps, the methods can also “consist essentially of” or “consist of” the various steps.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A pump, comprising:
a casing;
a mechanical seal arranged within the casing;
a flowline in fluid communication with the mechanical seal to circulate a flush and cooling fluid to or from the mechanical seal; and
a variable orifice flow device arranged in the flowline and actuatable between a fully closed position, where an open orifice is defined in the variable orifice flow device and allows the flush and cooling fluid to circulate through the variable orifice flow device at a first flow rate, and an open position, where the flush and cooling fluid circulates through the variable orifice flow device at a second flow rate greater than the first flow rate.

2. The pump of claim 1, further comprising:
an inlet that receives a process fluid into the casing;
an outlet that discharges the process fluid from the casing;
an impeller rotatably arranged within the casing; and
a drive shaft operatively coupled to the impeller and extending through an aperture defined in the casing, the mechanical seal being arranged at the aperture,
wherein the flush and cooling fluid comprises a portion of the process fluid.

3. The pump of claim 2, wherein the flowline extends between the outlet and a seal chamber in fluid communication with the mechanical seal, and wherein the flush and cooling fluid comprises a portion of the process fluid extracted from the outlet.

4. The pump of claim 2, wherein the flowline extends between the inlet and a seal chamber in fluid communication with the mechanical seal, and wherein the flush and cooling fluid is conveyed from the mechanical seal to the inlet.

5. The pump of claim 2, wherein the process fluid comprises a liquid selected from the group consisting of a hydrocarbon, water, a cooling fluid, a caustic, an acid, and any combination thereof.

6. The pump of claim 1, wherein the variable orifice flow device includes:
a valve body that provides an inlet port, an outlet port, and a flow path extending between the inlet and outlet ports;
an adjustable valve member movably positioned within the valve body and having opposing first and second ends; and
a head provided at the first end and engageable with a seating surface defined by the valve body within the flow path,
wherein, when the variable orifice flow device is in the fully closed position, the head engages the seating surface to define the open orifice within the flow path.

7. The pump of claim 6, wherein the head exhibits a generally frustoconical shape that defines a flat bottom.

8. The pump of claim 6, wherein the variable orifice flow device further includes a handle provided at the second end, and wherein manually rotating the handle causes the adjustable valve member to translate within the valve body and thereby transition the variable orifice flow device between the fully closed and open positions.

9. The pump of claim 6, wherein the adjustable valve member is rotated via a motor to transition the variable orifice flow device between the fully closed and open positions.

10. A method, comprising:
circulating a flush and cooling fluid through a flowline in fluid communication with a mechanical seal arranged within a casing of a pump;
conveying the flush and cooling fluid to a variable orifice flow device arranged in the flowline;
circulating the flush and cooling fluid through the variable orifice flow device in a fully closed position, where an open orifice is defined in the variable orifice flow device to allow the flush and cooling fluid to circulate through the variable orifice flow device at a first flow rate;
transitioning the variable orifice flow device away from the fully closed position; and
circulating the flush and cooling fluid through the variable orifice flow device at a second flow rate greater than the first flow rate with the variable orifice flow device transitioned away from the fully closed position.

11. The method of claim 10, wherein circulating the flush and cooling fluid through the variable orifice flow device at the second flow rate further comprises removing debris and residue from the flow path as the flush and cooling fluid circulates through the variable orifice flow device.

12. The method of claim 11, further comprising generating turbulent flow conditions within the flow path as the flush and cooling fluid circulates through the variable orifice flow device at the second flow rate.

13. The method of claim 10, wherein an impeller is rotatably arranged within the casing and a drive shaft is operatively coupled to the impeller and extends through an aperture defined in the casing where the mechanical seal is arranged, the method further comprising:
receiving a process fluid into the casing at an inlet;
discharging the process fluid from the casing at an outlet; and
using a portion of the process fluid as the flush and cooling fluid.

14. The method of claim 13, wherein the flowline extends between the outlet and a seal chamber in fluid communication with the mechanical seal, the method further comprising extracting a portion of the process fluid from the outlet to serve as the flush and cooling fluid.

15. The method of claim 13, wherein the flowline extends between the inlet and a seal chamber in fluid communication with the mechanical seal, the method further comprising conveying the flush and cooling fluid from the mechanical seal to the inlet.

16. The method of claim 10, wherein the variable orifice flow device includes:
a valve body that provides an inlet port, an outlet port, and a flow path extending between the inlet and outlet ports;
an adjustable valve member movably positioned within the valve body and having opposing first and second ends; and
a head provided at the first end and engageable with a seating surface defined by the valve body within the flow path,
the method further comprising:
engaging the head against the seating surface when the variable orifice flow device is in the fully closed position, and thereby defining the open orifice within the flow path.

17. The method of claim 16, wherein the variable orifice flow device further includes a handle provided at the second end, and wherein transitioning the variable orifice flow device away from the fully closed position comprises rotating the handle and thereby causing the adjustable valve member to translate within the valve body such that the head disengages with the seating surface.

18. A mechanical system, comprising:
a flowline through which a fluid is circulated; and
a variable orifice flow device arranged in the flowline and providing a valve body that includes an inlet port, an outlet port, and a flow path extending between the inlet and outlet ports,
wherein the variable orifice flow device is actuatable between a fully closed position, where an open orifice is defined in the variable orifice flow device to allow the fluid to circulate through the flow path at a first flow rate, and an open position, where the fluid circulates through the flow path at a second flow rate greater than the first flow rate.

19. The mechanical system of claim 18, wherein the variable orifice flow device further includes:
an adjustable valve member movably positioned within the valve body and having opposing first and second ends; and
a head provided at the first end and engageable with a seating surface defined by the valve body within the flow path,
wherein, when the variable orifice flow device is in the fully closed position, the head engages the seating surface to define the open orifice within the flow path.

20. The mechanical system of claim 19, wherein the variable orifice flow device further includes a handle provided at the second end, and wherein manually rotating the handle causes the adjustable valve member to translate within the valve body and thereby transition the variable orifice flow device between the fully closed and open positions.
